(19) United States
(12) Patent Application Publication
(10) Pub. No.: US 2012/0143850 A1
(43) Pub. Date: Jun. 7, 2012

(54) METHOD AND APPARATUS FOR MANAGING SCHEDULE INFORMATION IN PORTABLE TERMINAL

(75) Inventor: Byung Min JUNG, Seoul (KR)

(73) Assignee: SAMSUNG ELECTRONICS CO. LTD., Suwon-si (KR)

(21) Appl. No.: 13/272,600

(22) Filed: Oct. 13, 2011

(30) Foreign Application Priority Data
Dec. 6, 2010 (KR) 10-2010-0123146

(51) Int. Cl. G06F 17/30

(52) U.S. Cl. 707/722; 707/E17.005

(57) ABSTRACT

An information managing method and apparatus in a portable terminal are provided. The method for managing schedule information in a portable terminal, includes displaying schedules corresponding to a predefined time interval in a schedule searching mode, extracting at least one schedule, set as being important, from the displayed schedules when a request for searching for important schedules is generated, and displaying a list of important schedule information corresponding to the extracted at least one important schedule.

### PRIORITY

This application claims the benefit under 35 U.S.C. §119(a) of a Korean patent application filed on Dec. 6, 2010 in the Korean Intellectual Property Office and assigned Serial No. 10-2010-0123146, the entire disclosure of which is hereby incorporated by reference.

### BACKGROUND OF THE INVENTION

1. Field of the Invention

The present invention relates to an information managing method and apparatus in a portable terminal. More particularly, the present invention relates to a method for managing schedule information in a portable terminal and an apparatus thereof.

2. Description of the Related Art

In recent years, with the evolution of a portable terminal, the portable terminal may now perform various functions. That is, a recent portable terminal provides various functions such as a call function, a message transmitting/receiving function, a schedule managing function, and a file playing function according to a user request. Accordingly, the recent portable terminal stores a large amount of information due to execution of various functions. Further, the portable terminal provides information according to the request of a user. In this case, the information may contain call details, transmitted/received messages, schedules, voice files, and image files.

However, it is inconvenient for a portable terminal user to search for information in the portable terminal. For example, in a schedule searching mode, a portable terminal displays schedules during a predefined time interval. When one schedule is selected from the schedules, the portable terminal displays schedule information regarding the selected schedule. That is, to acquire the information regarding a corresponding schedule, a portable terminal user should select all the schedules one by one to determine whether they include desired schedule information. This deteriorates convenience for a user and utilization efficiency in the portable terminal.

### SUMMARY OF THE INVENTION

Aspects of the present invention are to address at least the above-mentioned problems and/or disadvantages and to provide at least the advantages described below. Accordingly, an aspect of the present invention is to provide a method for managing schedule information capable of easily searching the schedule information in a portable terminal, and an apparatus thereof.

In accordance with an aspect of the present invention, a method for managing schedule information is provided. The method includes displaying schedules corresponding to a predefined time interval in a schedule searching mode, extracting at least one schedule, set as being important, from the displayed schedules when a request for searching for important schedules is generated, and displaying a list of important schedule information corresponding to the extracted at least one important schedule.

In accordance with another aspect of the present invention, an apparatus for managing schedule information is provided. The apparatus includes a memory for storing schedule information of schedules registered in a schedule registration mode and information on whether the registered schedules are an important schedule, respectively, a display unit for displaying schedules during a predefined time interval in a schedule searching mode, and a controller for controlling the memory and the display unit, for controlling extraction of at least one schedule, set as being important, from the displayed schedules when a request for searching for important schedules is generated while displaying the schedules, and for controlling to display a list of important schedule information corresponding to the extracted at least one important schedule.

Since a method and an apparatus for managing schedule information in a portable terminal according to the present invention extract and display at least one schedule, set as being important, from specified schedules during a predefined time interval, a portable terminal user does not need to sequentially select and determine all the schedules to acquire a desired schedule. This improves the convenience for a user in a portable terminal. Furthermore, utilization efficiency of the portable terminal may be enhanced.

Other aspects, advantages, and salient features of the invention will become apparent to those skilled in the art from the following detailed description, which, taken in conjunction with the annexed drawings, disclose exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of an apparatus for managing schedule information in a portable terminal according to an exemplary embodiment of the present invention;

FIG. 2 is a flowchart illustrating a method for managing schedule information in a portable terminal according to an exemplary embodiment of the present invention;

FIG. 3 is a flowchart illustrating a procedure for searching for schedule information according to an exemplary embodiment of the present invention; and

FIG. 4A to FIG. 4J are views illustrating examples of a screen displayed when performing a method for managing schedule information in a portable terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition description of well-known functions and constructions may be omitted for clarity and conciseness.

The terms and words used in the following description and claims are not limited to their bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the term “schedule” denotes a plan determined by a user of a portable terminal. The schedule may indicate presence of corresponding schedule information. Here, the schedule information contains a date of a corresponding schedule such as year, month, and date, time such as hour and minute, and contents such as conference, appointment, reservation, and memorial. That is, the schedule is registered corresponding to a date of schedule information associated with schedule information.

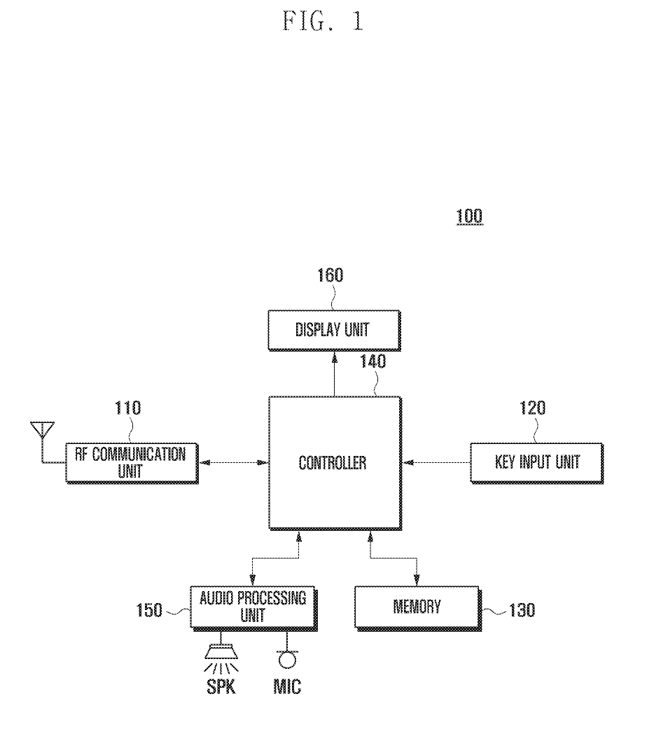

FIG. 1 is a block diagram illustrating a configuration of an apparatus for managing schedule information in a portable terminal according to an exemplary embodiment of the present invention. It is assumed in this exemplary embodiment that a portable terminal is a portable phone. However, exemplary embodiments of the present invention are equally applicable to any other portable terminal.

Referring to FIG. 1, a portable terminal 100 includes a Radio Frequency (RF) communication unit 110, a key input unit 120, a memory 130, a controller 140, an audio processing unit 150, and a display unit 160.

The RF communication unit 110 executes an RF communication function of the portable terminal 100. The RF communication unit 110 includes an RF transmitter for up-converting a frequency of a signal for transmission and amplifying the signal, and an RF receiver for low-noise-amplifying a received signal and down-converting a frequency of the signal.

The key input unit 120 includes keys for inputting numeral and text information and keys for executing various functions.

The memory 130 may include a program memory and a data memory. The program memory stores an operation program of the portable terminal 100 and programs for managing schedule information according to an exemplary embodiment of the present invention. The data memory stores data created during execution of a program. Further, the memory 130 stores schedules registered in a schedule registration mode according to an exemplary embodiment of the present invention. In this case, the memory 130 stores schedule information by schedules corresponding to respective schedules and presence of important schedules. Here, the schedule information contains a date of a corresponding schedule such as year, month, and date, time such as hour and minute, and contents such as conference, appointment, reservation, and memorial.

The controller 140 executes a function of controlling an overall operation of the terminal 100. The controller 150 includes a data processor, including a transmitter for encoding and modulating a signal for transmission and a receiver for demodulating and decoding a received signal. The data processor may be configured by a MODulator-DEModulator (MODEM) and a CODer-DECoder (CODEC). The CODEC includes a data CODEC for processing packet data, and an audio CODEC for processing an audio signal such as speech. Further, the controller 140 controls storage of schedules registered in a schedule registration mode according to an exemplary embodiment of the present invention. The controller 140 controls storage of schedule information by schedules corresponding to respective schedules and presence of important schedules. The controller 140 controls to display schedules during a predefined time interval in a schedule searching mode according to an exemplary embodiment of the present invention. In this case, the controller 140 controls extraction and the display of at least one important schedule from schedules during a predefined time interval according to an exemplary embodiment of the present invention. Here, the predefined time interval may be, for example, one month or one week.

The audio processing unit 150 plays an audio signal received from an audio CODEC of a data processor through a SPeaKer (SPK), and outputs an audio signal received through a MICrophone (MIC) to the audio CODEC of a data processor.

The display unit 160 displays a state of the portable terminal 100 under the control of the controller 140. In this case, the display unit 160 may be implemented in the form of a Liquid Crystal Display (LCD). The display unit 160 may include an LCD controller, a memory capable of storing display data, and an LCD display element. When the display unit 160 is implemented in the form of a touch screen, an LCD may act as an input unit.

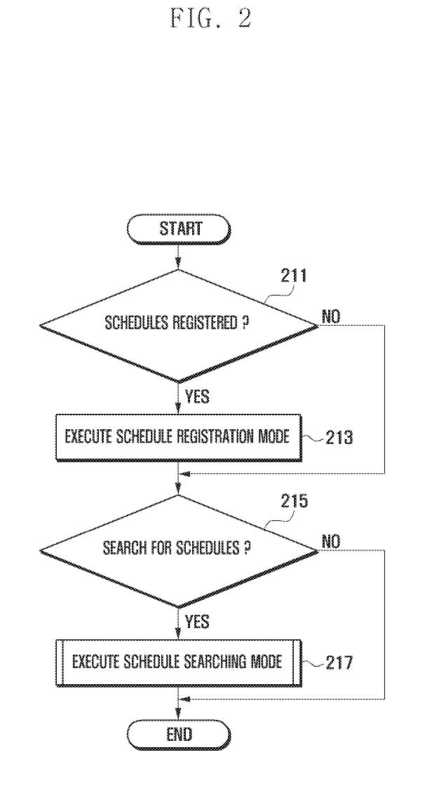

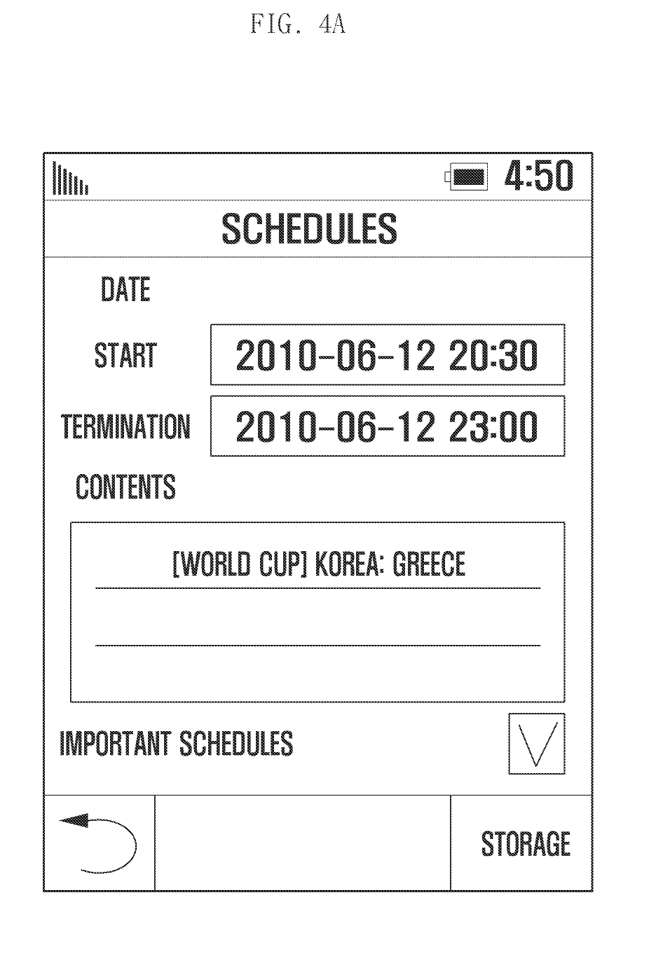

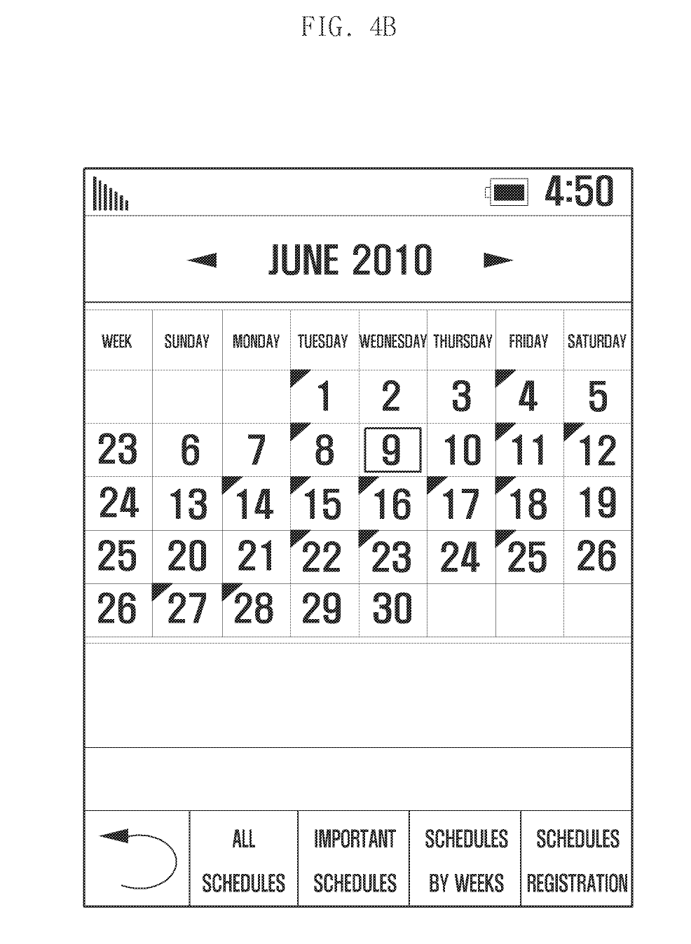

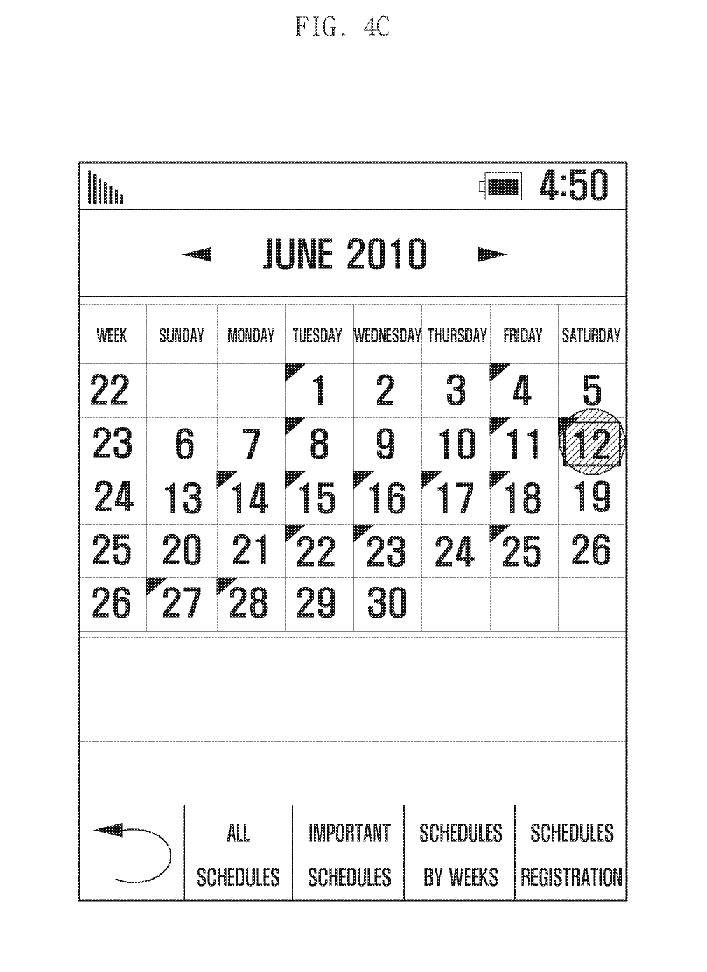

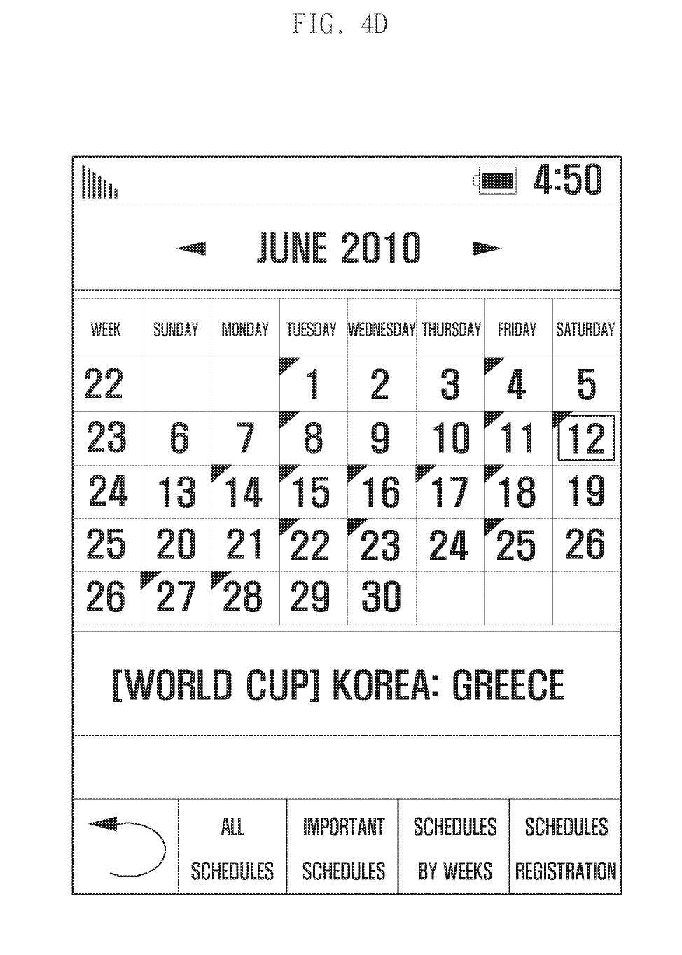

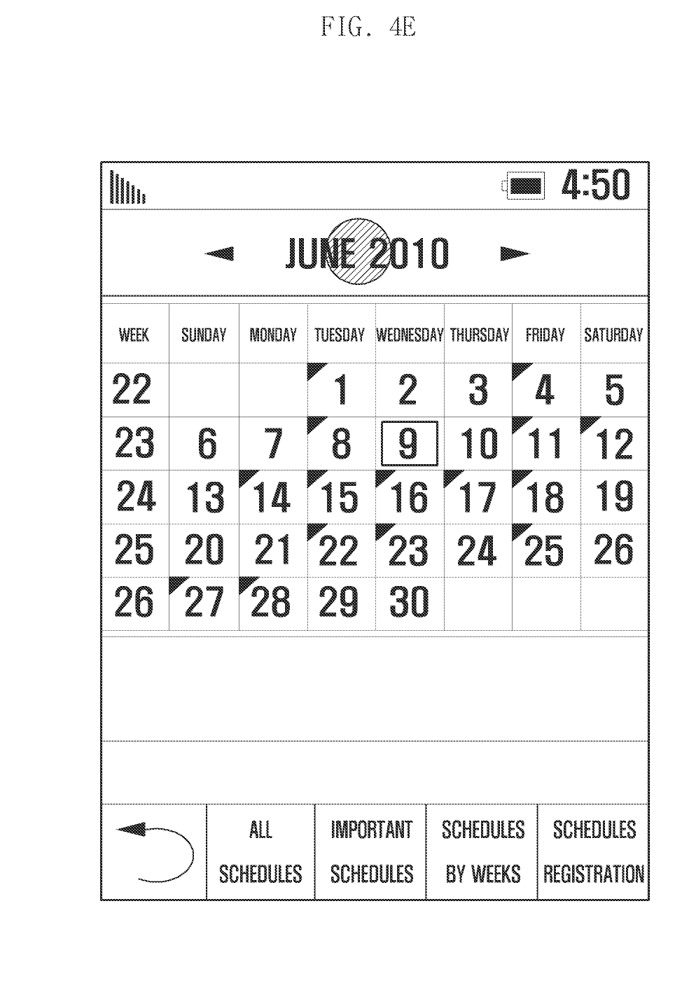

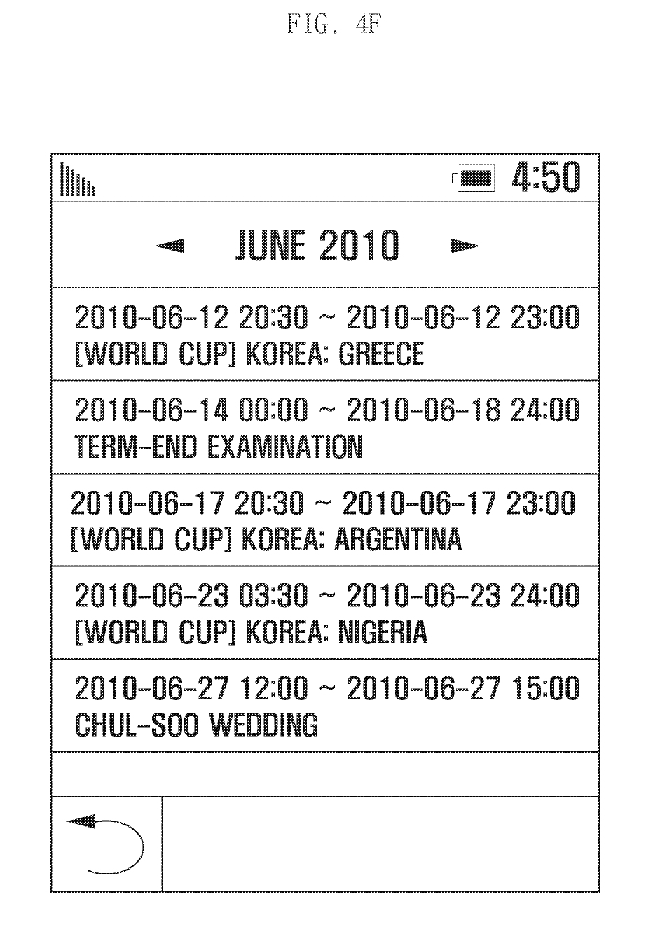

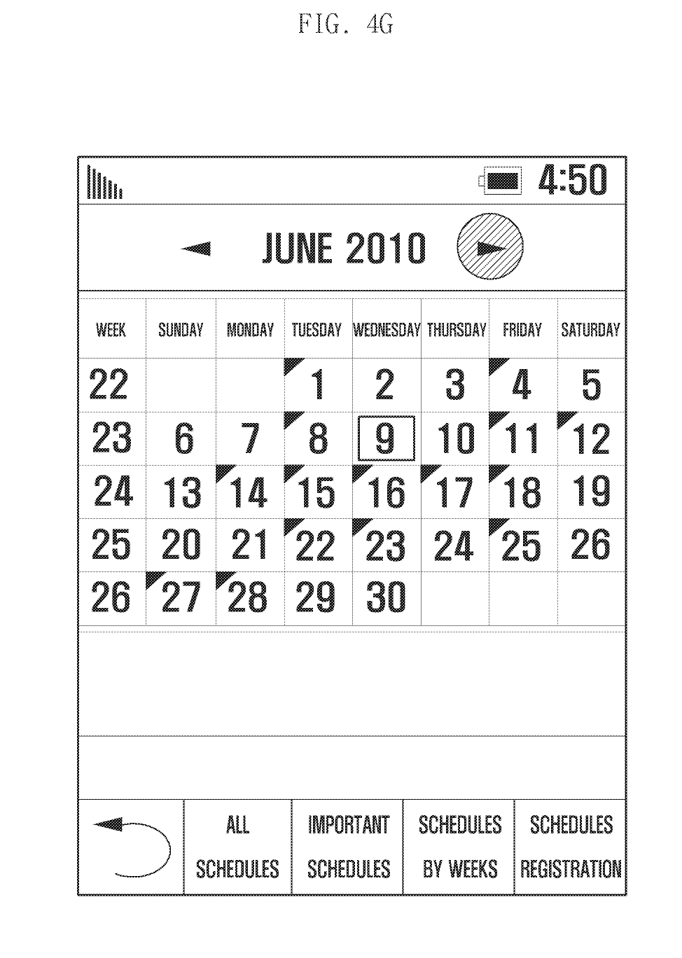

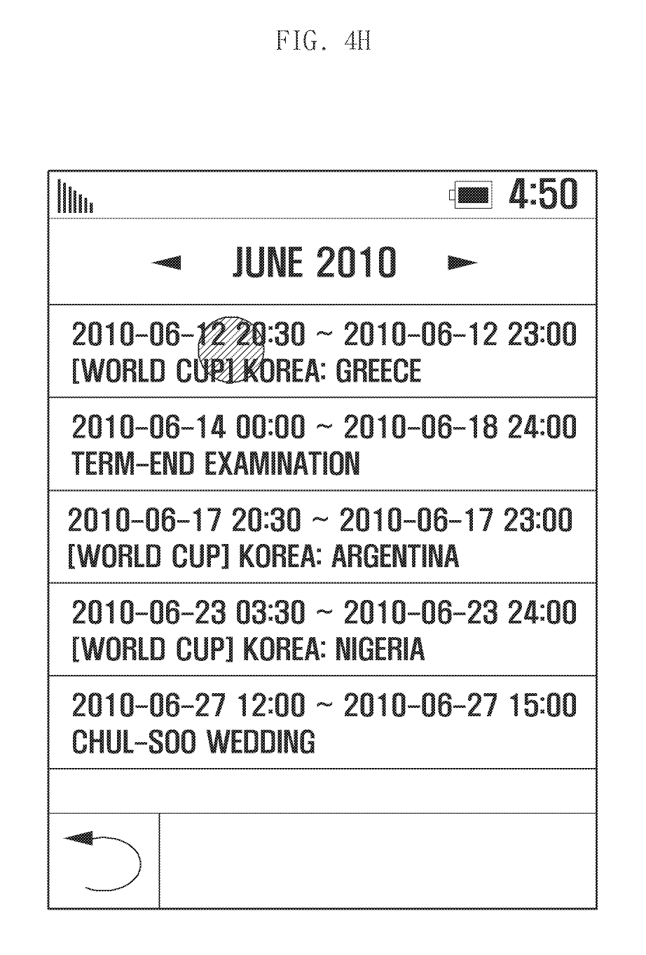

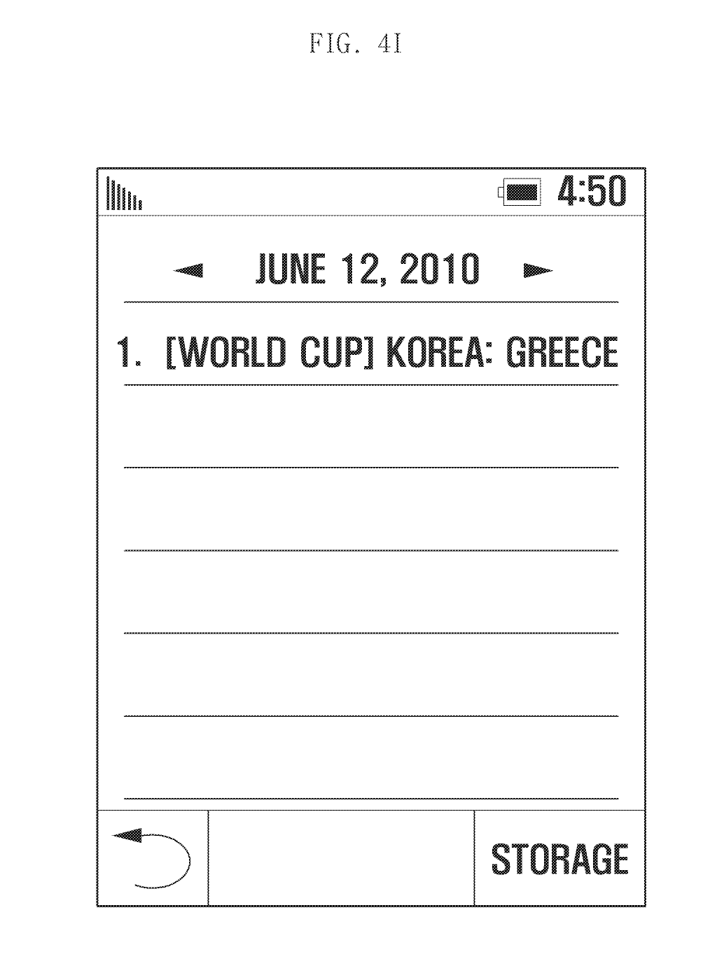

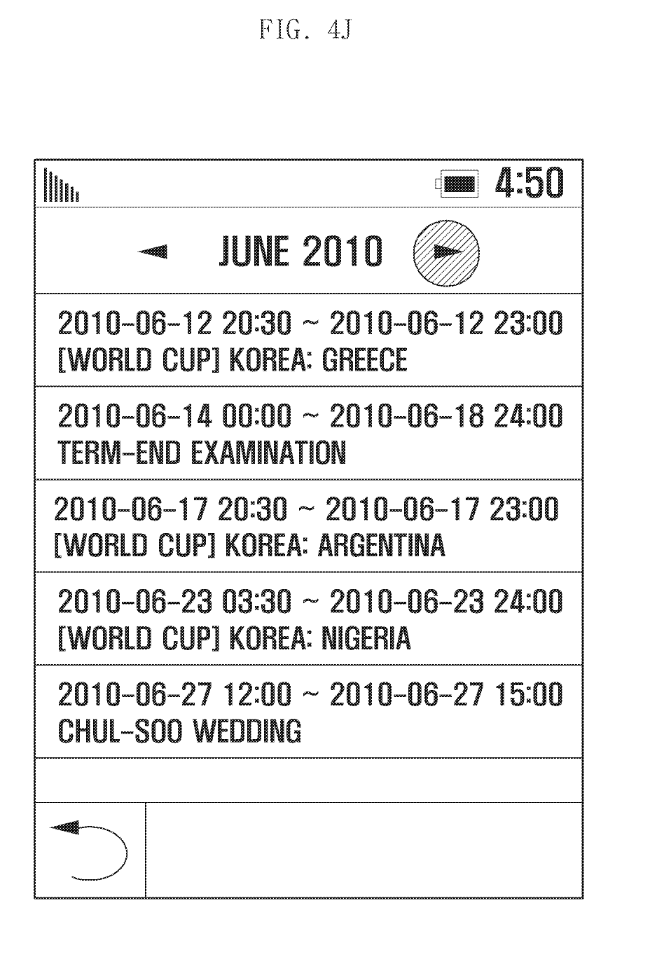

FIG. 2 is a flowchart illustrating a method for managing schedule information in a portable terminal according to an exemplary embodiment of the present invention. FIG. 4A to FIG. 4J are views illustrating examples of a screen displayed when performing a method for managing schedule information in a portable terminal according to an exemplary embodiment of the present invention.

Referring to FIG. 2, in a method for managing schedule information of a portable terminal 100 according to an exemplary embodiment of the present invention, a controller 140 first registers schedules. To do this, when a user of the portable terminal 100 requests registration of schedules, the controller 140 detects the request for schedule registration in step 211, and executes a schedule registration mode in step 213. Here, the request for schedule registration may be generated by the input unit 120, a touch screen, or a microphone. As shown in FIG. 4A, the controller 140 may register schedules in a schedule registration mode. That is, the controller 140 creates schedule information of the corresponding schedules according to selection of a portable terminal 100 user and stores the generated schedule information in the memory 130. Further, the controller 140 sets and stores presence of important schedules according to selection of the portable terminal 100 user in the memory 130. Here, a user of the portable terminal 100 may select schedule information of the corresponding schedules and presence of important schedules by the key input unit 120, a touch screen, or a microphone. That is, when a selection area for setting the corresponding schedules as important schedules is displayed and the selection area is then selected, the controller 140 may set the corresponding schedules as the important schedules. Through this, the memory 130 may store schedules together with respective schedule information and presence of important schedules as listed in a following table 1.

TABLE 1

| | | | | Presence |
|---|---|---|---|---|
| | | | | of im- |
| Date and time | | | | portant |
| Start | End | Information | . . . | schedule |
| — | — | — | — | — |
| — | — | — | — | — |
| — | — | — | — | — |
| 2010 May 20 08:30 | 2010 May 21 17:00 | Workshop | | TRUE |
| 2010 Jun. 01 10:00 | 2010 Jun. 01 11:00 | Week | | FALSE |
| | | conference | | |
| 2010 Jun. 04 16:30 | 2010 Jun. 04 17:00 | Week report | | FALSE |
| 2010 Jun. 08 10:10 | 2010 Jun. 08 11:00 | Week | | FALSE |
| | | conference | | |
| 2010 Jun. 11 16:40 | 2010 Jun. 11 17:00 | Week report | | FALSE |
| 2010 Jun. 12 20:30 | 2010 Jun. 12 23:00 | [World cup] | | TRUE |
| | | Korea: Greece | | |
| 2010 Jun. 14 00:00 | 2010 Jun. 18 24:00 | Term-end | | TRUE |
| | | examination | | |
| 2010 Jun. 15 10:00 | 2010 Jun. 15 11:00 | Week | | FALSE |
| | | conference | | |
| 2010 Jun. 17 20:30 | 2010 Jun. 17 23:00 | [World cup] | | TRUE |
| | | Korea: | | |
| | | Argentina | | |
| 2010 Jun. 18 16:30 | 2010 Jun. 18 17:00 | Week report | | FALSE |
| 2010 Jun. 22 10:00 | 2010 Jun. 22 11:00 | Week | | FALSE |
| | | conference | | |
| 2010 Jun. 23 03:30 | 2010 Jun. 23 24:00 | [World cup] | | TRUE |
| | | Korea: Nigeria | | |
| 2010 Jun. 25 16:30 | 2010 Jun. 25 17:00 | Week report | | FALSE |
| 2010 Jun. 27 12:00 | 2010 Jun. 27 15:00 | Chul-soo | | TRUE |
| | | wedding | | |
| 2010 Jun. 28 10:00 | 2010 Jun. 28 11:00 | Week | | FALSE |
| | | conference | | |
| 2010 Jul. 02 16:30 | 2010 Jul. 02 17:00 | Week report | | FALSE |
| 2010 Jul. 06 10:00 | 2010 Jul. 06 11:00 | Week | | FALSE |
| | | conference | | |
| 2010 Jul. 07 00:00 | 2010 Jul. 07 24:00 | My birth day | | TRUE |
| 2010 Jul. 09 16:30 | 2010 Jul. 09 17:00 | Week report | | FALSE |
| 2010 Jul. 13 10:00 | 2010 Jul. 13 11:00 | Week | | FALSE |
| | | conference | | |
| — | — | — | — | — |
| — | — | — | — | — |
| — | — | — | — | — |

Next, the controller 140 searches for schedules in a registered state of at least one schedule to acquire desired schedules. To do this, when a user of a portable terminal 100 requests searching for schedules, the controller 140 detects the request for searching for schedules in step 215, and executes a schedule searching mode in step 217. Here, the request for schedule registration may be generated by the input unit 120, a touch screen, or a microphone. As shown in at least one of FIG. 4B to FIG. 4J, the controller 140 may search schedule information in a schedule searching mode. In this case, the controller 140 may control to display schedules during a predefined time interval. Further, the controller 140 may extract and control to display at least one important schedule from the schedules during the predefined time interval. Here, a procedure for searching for schedule information in a schedule search mode by the controller 140 will be described in more detail.

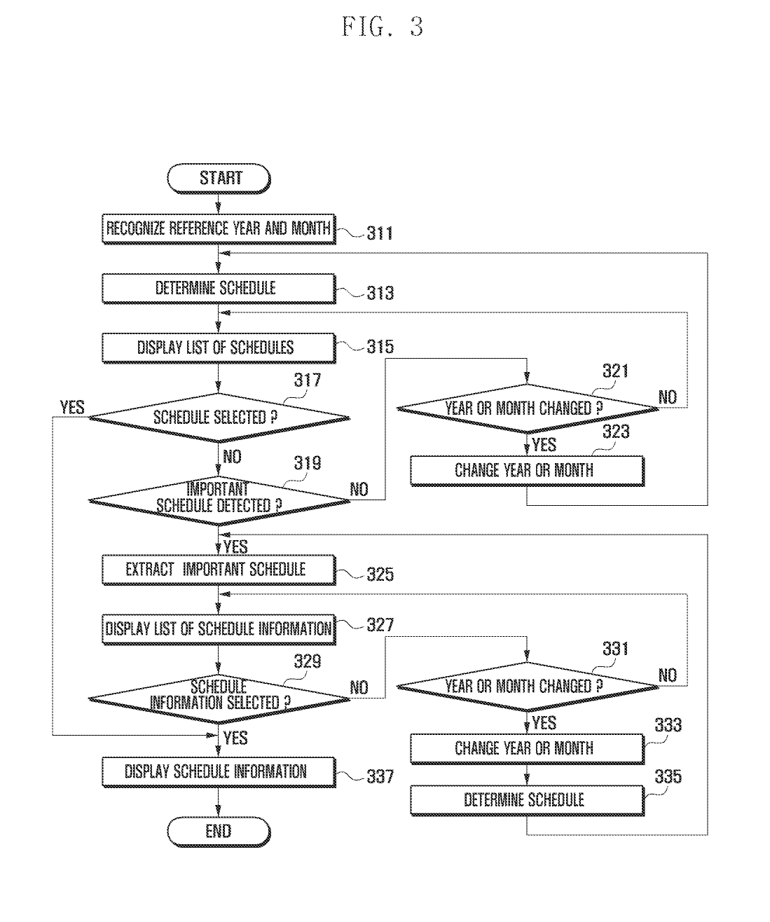

FIG. 3 is a flowchart illustrating a procedure for searching for schedule information according to an exemplary embodiment of the present invention.

Referring to FIG. 3, in a procedure for searching for schedule information by a controller 140 according an exemplary embodiment of the present invention, a controller 140 first recognizes a reference year and month in step 311. In this case, the reference year and month indicate a year and a month set to be respectively displayed when the controller 140 enters a schedule searching mode. Here, the reference year and month may be a year and a month of the current date. For example, when the current date is Jun. 9, 2010, the controller 140 may recognize the reference year and month as June 2010. That is, the controller 140 determines year and month to display corresponding to the reference year and month. For example, when the reference year and month is June 2010, the controller 140 may determine the year and month to display as June 2010.

Next, the controller 140 determines at least one schedule corresponding to the displayed year and month in step 313. That is, the controller 140 detects at least one schedule on a date thereof included in the displayed year and month from schedules registered in the memory 130 in the schedule registration mode. For example, when the displayed year and month is Jun. 6, 2010, the controller 140 may detect schedules of Jun. 1, 2010 to Jun. 28, 2010 in Table 1. Next, the controller 140 controls to display a list of schedules on the displayed year and month in step 315. At this time, the controller 140 may control to display dates by schedules in the list. For example, as shown in FIG. 4B, the controller 140 may control to display a presence of schedule registration, namely a presence of schedule information on respective dates of a calendar of the displayed year and month. The controller 140 may time interval data indicating the displayed year and month together with the list of schedules. The controller 140 may control to display an icon for changing the displayed year and month together with time interval data.

Subsequently, when at least one schedule is selected from schedules of a displayed list of schedules, the controller 140 detects the selected schedule in step 317 and controls to display schedule information thereof in step 337, and then the process returns to FIG. 2. For example, when a schedule on Jun. 12, 2010 is selected as shown in FIG. 4C, the controller 140 controls to display schedule information of a schedule on Jun. 12, 2010. Here, the controller 140 may control to display schedule information together with a calendar corresponding to the displayed year and month. Meanwhile, the controller 140 may control to display schedule information on a separate screen or window.

On the other hand, when selection of a schedule is not detected but a request for searching for important schedules is generated, the controller 140 detects the request for searching for important schedules in step 319, and extracts the important schedules from schedules corresponding to the displayed year and month in step 325. The request for searching for important schedules may be generated by a key input unit 120, a touch screen, or a microphone. For example, as shown in FIG. 4E, when time interval data indicating the displayed year and month are selected, the controller 140 may determine the selected time interval as the request for searching for important schedules. Further, the controller 140 extracts at least one set important schedule from schedules corresponding to the displayed year and month. For example, when the displayed year and month is June 2010, the controller 140 may extract schedules of Jun. 1, 2010 to Jun. 28, 2010 in which presence of important schedules is set to ‘TRUE’ in Table 1.

Subsequently, the controller 140 controls to display a list of schedule information of important schedules corresponding to the displayed year and month in step 327. For example, as shown in FIG. 4F, the controller 140 may control to display a list of respective schedule information in an order of dates of the important schedules. Further, the controller 140 may control to display time interval data indicating the display year and month together with a schedule information list of the important schedules. In addition, the controller 140 may control to display an icon for changing the display year and month together with the time interval data.

On the other hand, when the request for searching for important schedules is not detected but a request for changing the displayed year and month is generated at step 319, the controller 140 detects the request for changing the displayed year and month in step 321, and changes the displayed year and month in step 323, and the process returns to step 313. In this case, the request for changing the displayed year and month may be generated by the key input unit 120, a touch screen, or a microphone. For example, as shown in FIG. 4G, when an icon is selected, the controller 140 may determine the selected icon as the request for changing the displayed year and month. When the displayed year and month is June 2010, the controller 140 controls to change the displayed year and month to July 2010. Further, the controller 140 repeatedly performs at least one of step 313 to step 323. Next, the controller 140 performs step 325 and step 327. In step 321, when the request for changing the displayed year and month is not detected, the process returns to step 315.

When one schedule is selected from schedules of a schedule information list of important schedules at step 327, the controller 140 detects the selected schedule in step 329 and controls to display corresponding schedule information in step 337, and then the process returns to FIG. 2. For example, when schedule information of a schedule on 12 Jun. 2010 is selected as shown in FIG. 4H, the controller 140 controls to display schedule information of a schedule on 12 Jun. 2010 as shown in FIG. 4I. Here, the controller 140 may control to display schedule information on a separate screen or window.

On the other hand, when the schedule information is not selected but a request for changing the displayed year and month is generated at step 329, the controller 140 detects the request for changing the displayed year and month in step 331, and controls to change the displayed year and month in step 333. Here, the request for changing the displayed year and month may be generated by the key input unit 120, a touch screen, or a microphone. For example, when an icon is selected as shown in FIG. 4J, the controller 140 may detect the selected icon as the request for changing year and month. When the displayed year and month is June 2010, the controller 140 changes the displayed year and month to Jul. 7, 2010. After the controller 140 determines at least one schedule corresponding to the displayed year and month in step 335, the process returns to step 325. That is, the controller 140 detects at least one schedule on a date of schedule contents included in the displayed year and month from schedules registered in the memory 130 in a schedule registration mode. Further, the controller 140 repeatedly performs at least one of step 325 to step 335. In step 331, when the request for changing the displayed year and month is not detected, the process returns to step 327. Next, after the controller 140 performs step 337, the process returns to FIG. 2.

The foregoing exemplary embodiment of the present invention has described a case where the portable terminal separately displays schedules according to a time interval of one month. However, the present invention is not limited thereto. That is, the portable terminal may separately display schedules according to a predefined time interval to implement an exemplary embodiment of the present invention. For example, the portable terminal may separately display schedules for each week. Further, upon sensing a request for searching for important schedules, the portable terminal may extract important schedules for one week to display a list of schedule information.

In the exemplary embodiments of the present invention, because the portable terminal extracts and displays at least one set important schedule from schedules during a predefined time interval, a user of the portable terminal does not need to select and determine all the schedules one by one to acquire desired schedules. This improves convenience for a user and utilization efficiency in the portable terminal.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A method for managing schedule information in a portable terminal, the method comprising:
displaying schedules corresponding to a predefined time interval in a schedule searching mode;
extracting at least one schedule, set as being important, from the displayed schedules when a request for searching for important schedules is generated; and
displaying a list of important schedule information corresponding to the extracted at least one important schedule.

2. The method of claim 1, wherein the displaying of the schedules comprises:
displaying time interval data indicating the time interval; and
detecting selection of the time interval data as a request for searching for the at least one important schedule when the time interval data are selected while displaying the schedules.

3. The method of claim 2, wherein the displaying of the schedules further comprises:
displaying the time interval data; and
returning to the displaying of the schedules when the time interval data are selected while displaying the schedules.

4. The method of claim 1, further comprising:
extracting at least one important schedule from the displayed schedules during a changed time interval when the time interval changes while displaying the list of important schedule information; and
displaying the list of important schedule information corresponding to the extracted at least one important schedule.

5. The method of claim 1, further comprising setting whether a schedule to be registered is an important schedule in a schedule registration mode.

6. The method of claim 5, wherein the setting of whether the schedule to be registered is the important schedule comprises:
displaying a selection area for setting the schedule to be registered as the important schedule; and
setting the schedule to be registered as the important schedule when the selection area is selected.

7. The method of claim 1, further comprising displaying schedule information of a selected schedule when one schedule is selected from the displayed schedules.

8. The method of claim 1, further comprising:
detecting a selection of important schedule information from among the list of important schedule information; and
displaying the selected important schedule information.

9. An apparatus for managing schedule information in a portable terminal, the apparatus comprising:
a memory for storing schedule information of schedules registered in a schedule registration mode and information on whether the registered schedules are an important schedule, respectively;
a display unit for displaying schedules during a predefined time interval in a schedule searching mode; and
a controller for controlling the memory and the display unit, for controlling extraction of at least one schedule, set as being important, from the displayed schedules when a request for searching for important schedules is generated while displaying the schedules, and for controlling to display a list of important schedule information corresponding to the extracted at least one important schedule.

10. The apparatus of claim 9, wherein the controller controls to display time interval data indicating the predefined time interval upon displaying the schedules, and detects selection of the time interval data as a request for searching for the at least one important schedule when the time interval data are selected while displaying the schedules.

11. The apparatus of claim 10, wherein the controller controls to display the time interval data upon displaying the schedules, and returns to displaying the schedules when the time interval data are selected while displaying the schedules.

12. The apparatus of claim 9, wherein the controller controls extraction of at least one important schedule from the displayed schedules corresponding to a changed time interval when the time interval changes while displaying the list of important schedule information, and displaying of the list of important schedule information corresponding to the extracted at least one schedule.

13. The apparatus of claim 9, wherein the controller sets and stores whether a schedule to be registered is an important schedule in the schedule registration mode in the memory.

14. The apparatus of claim 13, wherein the controller controls to display a selection area for setting the schedule to be registered as the important schedule, and sets the schedule to be registered as the important schedule when the selection area is selected.

15. The apparatus of claim 9, wherein the controller controls to display schedule information of a selected schedule when one schedule is selected from the displayed schedules.

16. The apparatus of claim 9, wherein the controller detects a selection of important schedule information from among the list of important schedule information, and controls to display the selected important schedule information.
